(19) United States
(12) Patent Application Publication
(10) Pub. No.: US 2026/0323366 A1
(43) Pub. Date: Oct. 15, 2026

(54) METHOD AND RELATED DEVICE FOR FREQUENCY BAND USAGE MANAGEMENT IN MULTI-LINK OPERATION ARCHITECTURE

(71) Applicant: ASUSTeK COMPUTER INC., Taipei City (TW)

(72) Inventors: Tz-Yi Chiu, Taipei City (TW); Meng-Chieh Huang, Taipei City (TW); ChengChe Wu, Taipei City (TW)

(73) Assignee: ASUSTeK COMPUTER INC., Taipei City (TW)

(21) Appl. No.: 19/642,640

(22) Filed: Apr. 9, 2026

(30) Foreign Application Priority Data
Apr. 11, 2025 (TW) 114113798

(51) Int. Cl. H04W 28/02; H04W 24/08

(52) U.S. Cl. CPC H04W 28/0236; H04W 24/08; H04W 28/0268

(57) ABSTRACT

A method and a related device for a frequency band usage management in a multi-link operation architecture are provided. The method comprises the following steps. A transmission status of an operating frequency band of a link of a multi-link operation is monitored. Whether the operating frequency band of the link is interfered is determined. When the operating frequency band of the link is interfered, a transmission restriction is performed on the link based on a packet characteristic of a transmission packet.

### CROSS-REFERENCE TO RELATED APPLICATION

This application claims the priority benefit of Taiwan application serial no. 114113798, filed on Apr. 11, 2025. The entirety of the above-mentioned patent application is hereby incorporated by reference herein and made a part of this specification.

### BACKGROUND

### Technical Field

The disclosure relates to a method and a related device for a frequency band usage management in a multi-link operation architecture.

### Description of Related Art

In conventional Wi-Fi technology, when an operating frequency band of a link is interfered, a method of changing a channel or a bandwidth is usually adopted to avoid interference. However, as a number of network-connectable devices increases and channel resources are limited, completely avoiding interference has become extremely challenging, thereby affecting overall performance of a wireless network.

The introduction of a multi-link operation (MLO) technology enables wireless devices to use multiple frequency bands at the same time for data transmission, so as to improve stability and speed of connection. However, this also leads to more situations of sharing frequency bands with other devices, and sources of interference increase accordingly. In an embodiment, in a mesh network architecture, a same frequency band may be adopted to connect a mesh extender node and a mesh router and a terminal device, resulting in interference. Although an existing MLO technology is capable of distributing traffic to different frequency bands according to a transmission status to reduce a load of an interfered frequency band, there still exists a risk of packet loss under a high interference condition. Packet loss borne by the interfered frequency band causes other non-interfered frequency bands to wait for the frequency band to complete transmission before continuing, thereby reducing overall data transmission efficiency.

### SUMMARY

The disclosure provides a method for a frequency band usage management in a multi-link operation architecture. The method comprises the following steps. A transmission status of an operating frequency band of a link of a multi-link operation is monitored. Whether the operating frequency band of the link is interfered is determined. When the operating frequency band of the link is interfered, a transmission restriction is performed on the link based on a packet characteristic of a transmission packet.

The disclosure also provides a device. The device comprises a transceiver, a storage device, and a processor. The processor is coupled to the transceiver and the storage device, and is configured to perform the following operations. A transmission status of an operating frequency band of a link of a multi-link operation is monitored. Whether the operating frequency band of the link is interfered is determined. When the operating frequency band of the link is interfered, a transmission restriction is performed on the link based on a packet characteristic of a transmission packet.

Based on the above, in the embodiments of the disclosure, when it is monitored that an operating frequency band of a link in the multi-link operation is interfered, a transmission restriction rule of the interfered link may be set to determine whether the transmission packet may be scheduled to the interfered link according to the packet characteristic. That is, when it is monitored that the operating frequency band of a link of the multi-link operation is interfered, a transmission opportunity of the link is restricted to ensure overall data transmission efficiency and stability of the multi-link operation. Therefore, the quality and performance of a network connection are both improved.

### BRIEF DESCRIPTION OF THE DRAWINGS

FIG. 1 is a schematic diagram of a multi-access point network system according to an embodiment of the disclosure.

FIG. 2 is a schematic diagram of a wireless access point device according to an embodiment of the disclosure.

FIG. 3 is a flowchart of a method for a frequency band usage management in a multi-link operation architecture according to an embodiment of the disclosure.

FIG. 4 is a flowchart of a method for a frequency band usage management in a multi-link operation architecture according to an embodiment of the disclosure.

FIG. 5 is a flowchart of a method for a frequency band usage management in a multi-link operation architecture according to an embodiment of the disclosure.

FIG. 6 is a schematic diagram of a method for a frequency band usage management in a multi-link operation architecture according to an embodiment of the disclosure.

FIG. 7 is a flowchart of a method for a frequency band usage management in a multi-link operation architecture according to an embodiment of the disclosure.

FIG. 8 is a flowchart of performing a transmission restriction based on an interference degree and a packet characteristic according to an embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts. These exemplary embodiments are only a part of the disclosure, and do not disclose all of the ways in which this disclosure may be implemented. More specifically, these exemplary embodiments are only examples of the device and method in the claims of the disclosure.

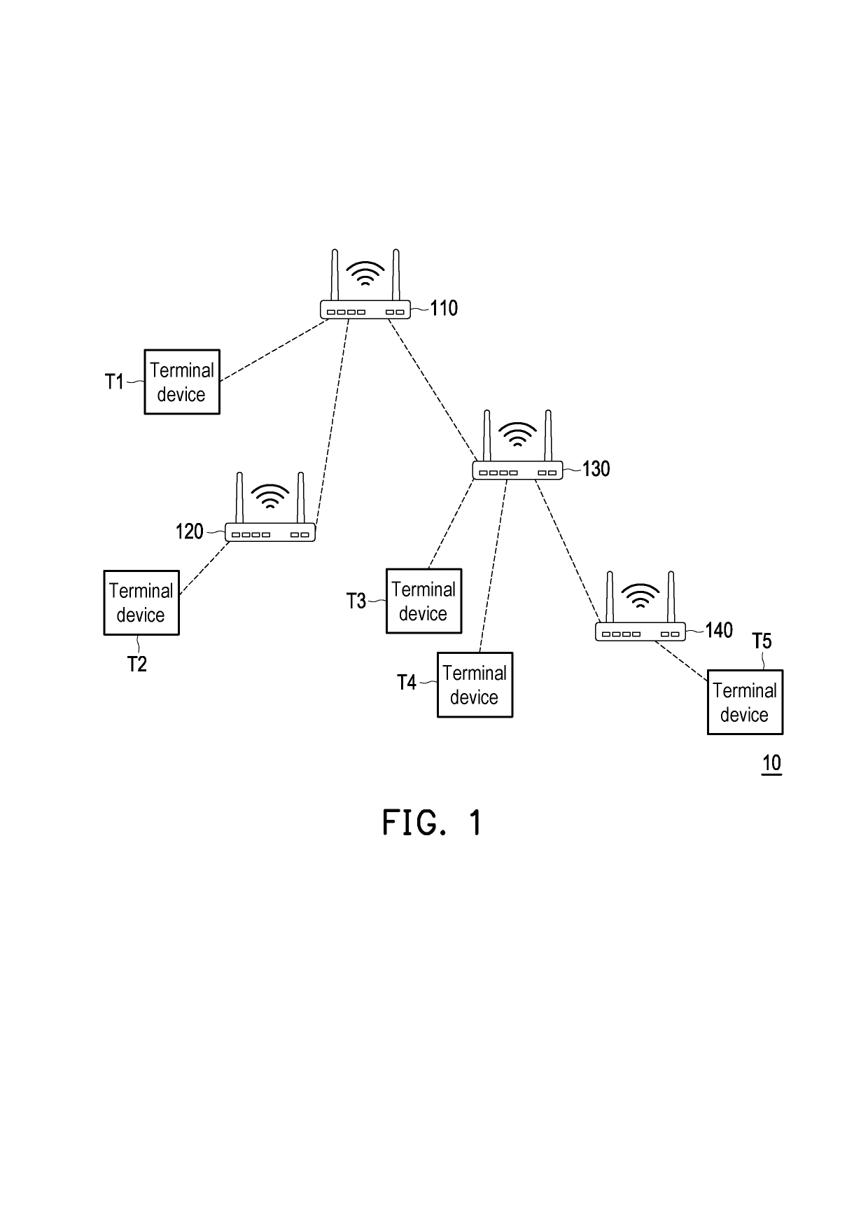

Referring to FIG. 1, which is a schematic diagram of a multi-access point network system according to an embodiment of the disclosure, a multi-access point network system 10 comprises a plurality of wireless access point devices 110 to 140 and a plurality of terminal devices T1 to T5.

In some embodiments, the wireless access point devices 110 to 140 are wireless routers that provide wireless communication functions based on a WiFi protocol. In some embodiments, the wireless access point devices 110 to 140 support the IEEE 802.11 protocol. The terminal devices T1 to T5 are connected to the Internet through the wireless access point devices 110 to 140.

In some embodiments, the wireless access point devices 110 to 140 form a mesh network. The wireless access point device 110 is a main router (also referred to as a main access point, a central access point, or a root access point) of the mesh network. The wireless access point device 110 serves as a gateway that connects the mesh network to a public Internet. The wireless access point device 110 is connected to the Internet through a modem or a fiber converter of an Internet service provider (ISP). In addition, the wireless access point devices 120 to 140 are sub-routers (also referred to as sub-access points, subordinate access points, or extended access points) of the mesh network. The wireless access point devices 120 to 140 extend a coverage area of a wireless signal.

In some embodiments, the wireless access point devices 110 to 140 support the IEEE 802.11 k/v/r protocol or the IEEE 802.11s protocol. Or, the wireless access point devices 110 to 140 support the EasyMesh standard defined by the Wi-Fi Alliance. In some embodiments, when the wireless access point devices 110 to 140 form a mesh WiFi, the wireless access point device 110 is a central controller of multiple access points (Multi-AP), and the wireless access point devices 120 to 140 are agents of the Multi-AP.

In some embodiments, the wireless access point devices 110 to 140 adopt a 2.4 GHz, 5 GHz, and 6 GHz frequency band or a combination thereof to perform wireless communication with the terminal devices T1 to T5. In an embodiment, the wireless access point device 110 adopts the 5 GHz to establish a corresponding link with the terminal device T1. In some embodiments, the wireless access point devices 110 to 140 also adopts a 2.4 GHz, 5 GHz, 6 GHz frequency band or a combination thereof to establish a link with one another. In an embodiment, the wireless access point device 110 adopts the 2.4 GHz and the 5 GHz to establish two corresponding links with the wireless access point device 120.

In some embodiments, the terminal devices T1 to T5 are smart phones, tablet computers, game consoles, notebook computers, desktop computers, smart home appliances, Internet of Things devices, and so on, and the disclosure is not limited thereto. The terminal devices T1 to T5 are connected to the Internet by connecting to the wireless access point devices 110 to 140.

In some embodiments, the wireless access point devices 110 to 140 support a multi-link operation (MLO), so that multiple operating frequency bands are used at the same time to establish links. Through the MLO, the wireless access point devices 110 to 140 use multiple connections more effectively to achieve a faster and more stable wireless network connection. In an embodiment, the wireless access point device 110 as a main router and the wireless access point device 120 as a mesh extender node establish multiple links on multiple operating frequency bands (2.4 GHz, 5 GHz, and 6 GHz) at the same time to share a data transmission task through each link.

In addition, it is to be noted that although FIG. 1 is described by taking a multi-access point network as a mesh network as an example, the method of the disclosure is not limited to being implemented on a mesh network.

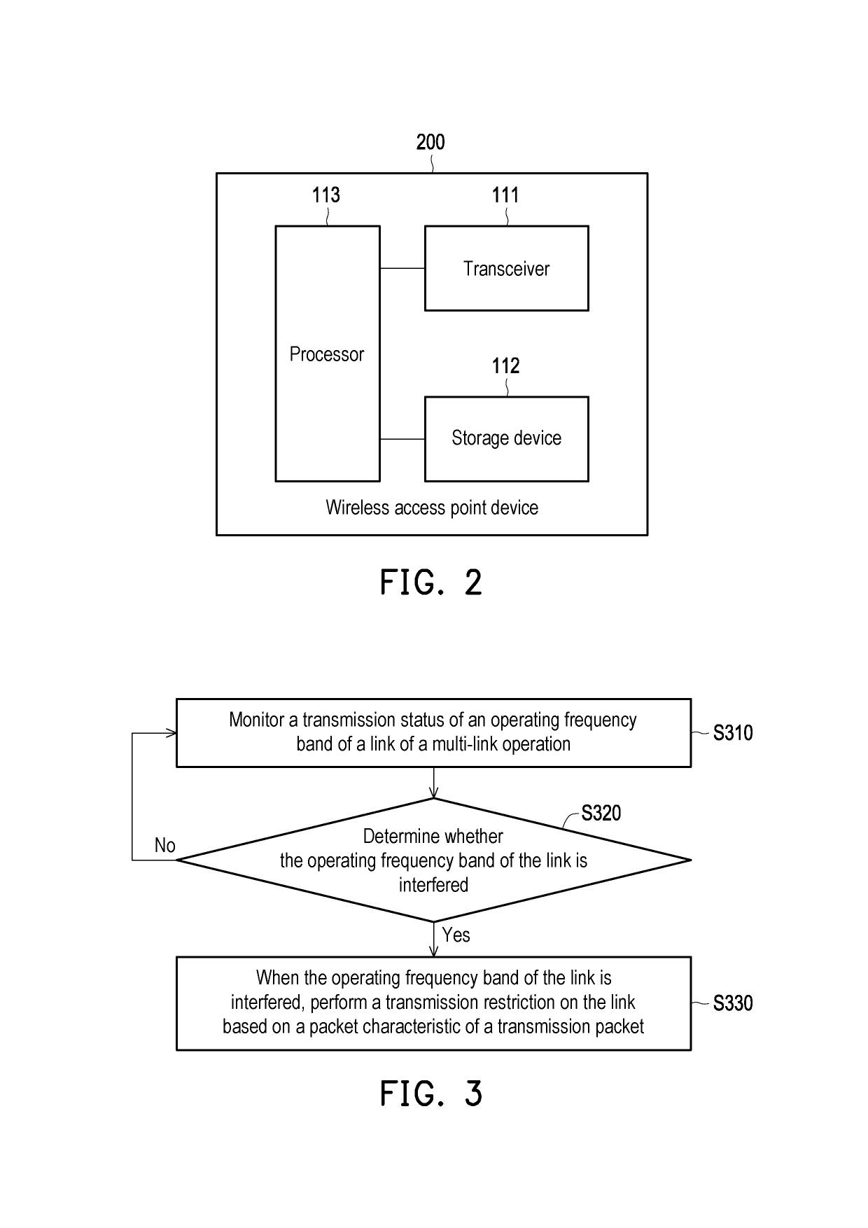

Referring to FIG. 2, which is a schematic diagram of a router device according to an embodiment of the disclosure, a wireless access point device 200 is any one of the wireless access point devices 110 to 140 of the embodiment shown in FIG. 1. The wireless access point device 200 comprises a transceiver 111, a storage device 112, and a processor 113. The processor 113 is coupled to the transceiver 111 and the storage device 112.

The transceiver 111 transmits and receives signals in a wireless or wired manner. In an embodiment, the transceiver further performs operations such as low-noise amplification, impedance matching, mixing, up or down frequency conversion, filtering, amplification, and similar operations. The wireless access point device 200 receives and transmits data through the transceiver 111. In some embodiments, the wireless access point device 200 further comprises an antenna (not shown).

The storage device 112 is configured to store data such as files, instructions, codes, software modules, and so on. In an embodiment, the storage device 112, is any type of fixed or removable random access memory (RAM), read-only memory (ROM), flash memory, or other similar device, integrated circuit, or a combination thereof.

In an embodiment, the processor 113 is a programmable general-purpose or special-purpose microprocessor, digital signal processor (DSP), programmable controller, application-specific integrated circuit (ASIC), programmable logic device (PLD), or other similar device, or a combination of these devices.

In an embodiment, the processor 113 executes codes, software/firmware modules, instructions, and so on recorded in the storage device 112 to implement the method for a frequency band usage management in a multi-link operation architecture according to the embodiment of the disclosure. In other words, the processor 113 is respectively configured to execute operations that correspond to respective descriptions in the following text.

Referring to FIG. 3, which is a flowchart of a method for a frequency band usage management in a multi-link operation architecture according to an embodiment of the disclosure, the method of the this embodiment is executed by the wireless access point device 200 of FIG. 2, and the details of each step are described below with reference to the elements shown in FIG. 2.

In step S310, the processor 113 monitors a transmission status of an operating frequency band of a link of a multi-link operation. In some embodiments, in response to a terminal device that supports the MLO or another wireless access point device connecting to the wireless access point device 200, the processor 113 starts monitoring the transmission status of the operating frequency band of a link of a multi-link operation. Specifically, in some embodiments, when the wireless access point device 200 and a connected device that supports the MLO (e.g., a terminal device or another wireless access point device) establish a plurality of links corresponding to a plurality of operating frequency bands, the processor 113 records information of the connected device and the plurality of operating frequency bands used when being connected to the connected device. Thereafter, the processor 113 starts monitoring the transmission status of these operating frequency bands.

In some embodiments, the processor 113 obtains a real-time transmission status of the operating frequency band by monitoring related parameters of the operating frequency band of the link, such as signal strength, channel utilization rate, packet loss rate, or interference index.

In some embodiments, the processor 113 detects an occupancy status or an interference period of the operating frequency band of the link within a preset time period to obtain a real-time transmission status of the operating frequency band.

In step S320, the processor 113 determines whether the operating frequency band of the link is interfered. Specifically, according to the transmission status of the operating frequency band of the link, the processor 113 determines whether the operating frequency band of the link is interfered.

In some embodiments, the processor 113 determines whether an interference degree of the operating frequency band has reached a level that affects transmission performance based on the collected transmission status information of the operating frequency band, such as a rapid drop of signal strength, an increase in packet loss rate, or an interference index exceeding a predetermined threshold.

In some embodiments, the processor 113 determines whether the operating frequency band of the link is interfered according to a duration of an interference period. In some embodiments, the processor 113 determines whether the operating frequency band of the link is interfered according to a duration of an occupancy period during which the operating frequency band of the link is occupied by other devices within a preset time period. In some embodiments, the processor 113 determines whether the operating frequency band of the link is interfered according to a duration of a contention-free period of the operating frequency band of the link within a preset time period. In some embodiments, the processor 113 determines whether the operating frequency band of the link is interfered according to a duration of a self-occupancy period of the operating frequency band of the link within a preset time period.

In step S330, when the operating frequency band of the link is interfered, the processor 113 performs a transmission restriction on the link based on a packet characteristic of a transmission packet. Specifically, when the processor 113 determines that the operating frequency band of a link is interfered, the processor 113 configures a transmission restriction rule of the link to restrict a transmission opportunity of the link. Based on this, a negative impact of the interfered operating frequency band on transmission performance of other operating frequency bands is avoided.

In some embodiments, when the processor 113 determines that the operating frequency band of a link is interfered, the processor 113 suspends a transmission through the link. In some embodiments, when the processor 113 determines that the operating frequency band of a link is interfered, the processor 113 allows transmission packets that meet specific conditions to be transmitted through the link and disable transmission packets that do not meet the specific conditions from being transmitted through the link. The specific conditions comprises whether a priority level of the transmission packet is a high priority level. The specific conditions comprises whether a transmission protocol of the transmission packet is a specific transmission protocol, such as a Transmission Control Protocol (TCP) or a User Datagram Protocol (UDP). In an embodiment, when the operating frequency band of a link is interfered, the processor 113 disables transmission packets using the UDP from being transmitted through the link.

In some embodiments, when the operating frequency band of the link is switched to be not interfered, the processor 113 removes the transmission restriction on the link. That is, when the operating frequency band of the link is switched to be not interfered, the processor 113 cancels the transmission restriction of the link and restore a transmission opportunity for the link. It is thus understood that the transmission restriction of the link of the MLO is dynamically configured according to a real-time interference status.

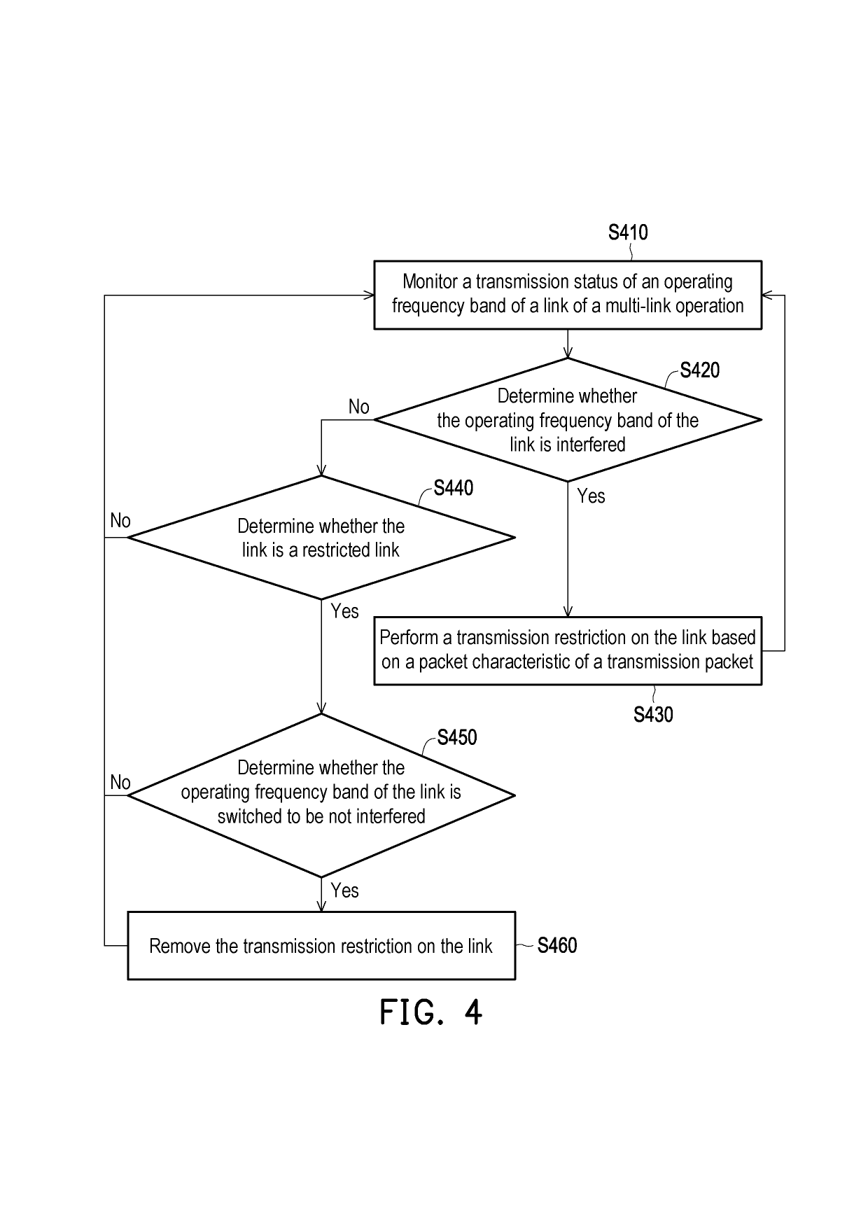

Referring to FIG. 4, which is a flowchart of a method for a frequency band usage management in a multi-link operation architecture according to an embodiment of the disclosure, the method of the this embodiment is executed by the wireless access point device 200 of FIG. 2, and the details of each step are described below with reference to the elements shown in FIG. 2.

In step S410, the processor 113 monitors a transmission status of an operating frequency band of a link of a multi-link operation. In step S420, the processor 113 determines whether the operating frequency band of the link is interfered. In step S430, when the operating frequency band of the link is interfered, the processor 113 performs a transmission restriction on the link based on a packet characteristic of a transmission packet. Detailed implementations of steps S410 to S430 are referred to the descriptions of the above embodiments and will not be repeated here.

In step S440, when the operating frequency band of the link is not interfered, the processor 113 determines whether the link is configured as a restricted link. Specifically, when the processor 113 performs a transmission restriction on a link, the link is configured as a restricted link. That is, when the operating frequency band of the link is not interfered, the processor 113 determines whether the link has been configured as a restricted link due to an interference that occurred in the past.

In step S450, when the link is configured as a restricted link, the processor 113 determines whether the operating frequency band of the link is switched to be not interfered. In step S460, when the operating frequency band of the link is switched to be not interfered, the processor 113 removes the transmission restriction on the link.

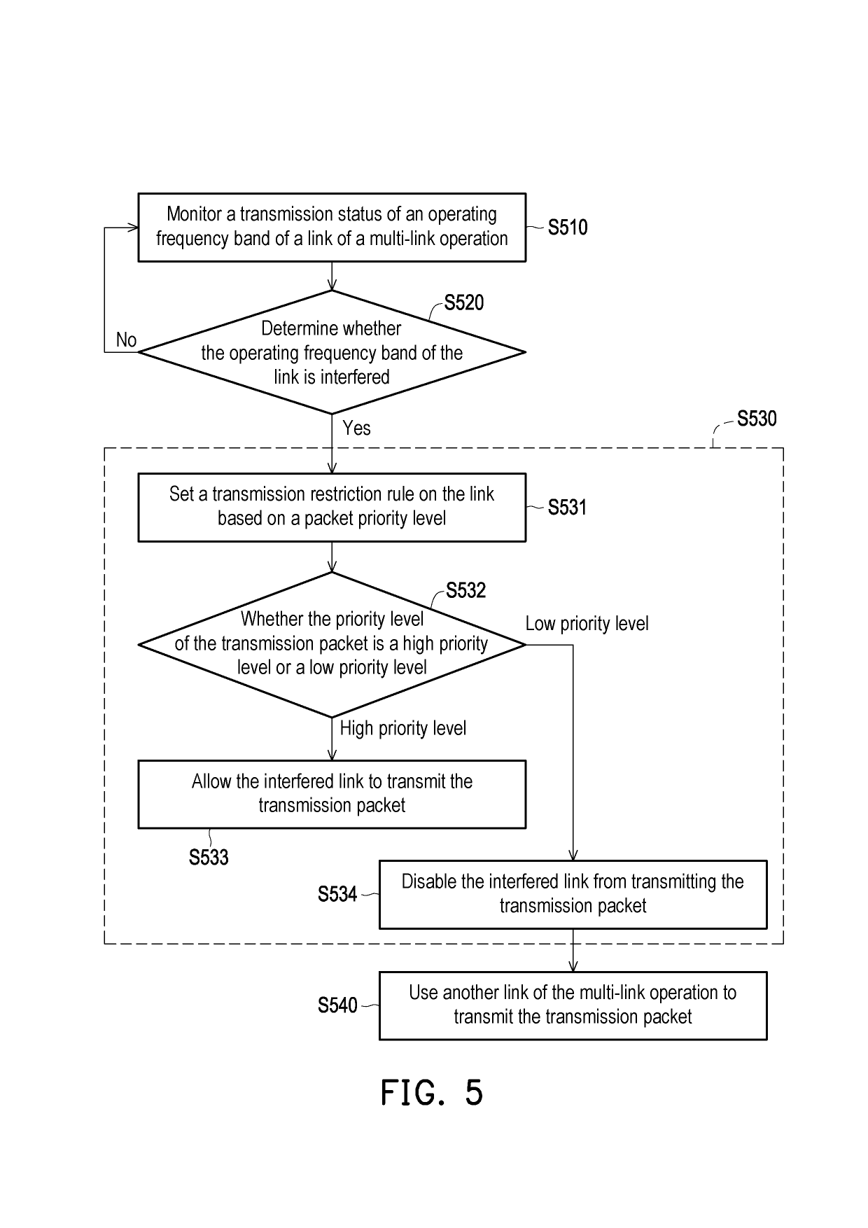

Referring to FIG. 5, which is a flowchart of a method for a frequency band usage management in a multi-link operation architecture according to an embodiment of the disclosure, the method of the this embodiment is executed by the wireless access point device 200 of FIG. 2, and the details of each step are described below with reference to the elements shown in FIG. 2.

In step S510, the processor 113 monitors a transmission status of an operating frequency band of a link of a multi-link operation. In step S520, the processor 113 determines whether the operating frequency band of the link is interfered. Detailed implementations of steps S510 to S520 are referred to the descriptions of the above embodiments and will not be repeated here.

In step S530, when the operating frequency band of the link is interfered, the processor 113 performs a transmission restriction on the link based on a packet characteristic of a transmission packet. In some embodiments, when the operating frequency band of the link is interfered, the processor 113 performs the transmission restriction on the link according to a priority level of the transmission packet. That is, when the operating frequency band of the link is interfered, the processor 113 determines whether the transmission packet is transmitted through the interfered operating frequency band based on the priority of the transmission packet.

In some embodiments, step S530 is implemented as steps S531 to S534. In step S531, when the operating frequency band of the link is interfered, the processor 113 sets a transmission restriction rule on the link based on a packet priority level. Specifically, in some embodiments, when the operating frequency band of the link is interfered, the processor 113 chooses to use a transmission restriction rule based on the packet priority level or a transmission restriction rule based on another packet characteristic. In some embodiments, when the operating frequency band of the link is interfered and the processor adopts the transmission restriction rule based on the packet priority level, the processor 113 determines a priority level threshold to distinguish high-priority packets from low-priority packets.

In step S532, the processor 113 determines whether a priority level of the transmission packet is a high priority level or a low priority level. More specifically, the processor 113 first determines the priority level of the transmission packet and then determine whether the priority level of the transmission packet is a high priority level or a low priority level.

In some embodiments, the processor 113 compares a priority level of a transmission packet with a priority level threshold, and determine whether the priority level of the transmission packet is a high priority level or a low priority level based on a comparison result. Or, in some embodiments, the processor 113 looks up a pre-established lookup table according to the priority level of the transmission packet to determine whether the priority level of the transmission packet is a high priority level or a low priority level.

In some embodiments, the priority level of the transmission packet is determined according to a traffic identifier (TID) defined by QoS. The traffic identifier is used to indicate a traffic type and a processing priority order of the transmission packet. Specifically, the wireless access point device 200 having MLO capability allows data transmission and reception to be performed on multiple link connections over single or multiple frequency bands of 2 GHz, 5 GHz, and 6 GHz according to different QoS requirements.

In some embodiments, the traffic identifier is designed according to a Wi-Fi QoS specification (for example, IEEE 802.11e), and is used to indicate which access category (AC) the transmission packet belongs to, such as voice traffic, video traffic, best effort traffic, or background traffic. These categories further affect a processing priority order and a resource allocation policy during a transmission process of the packet. In some embodiments, the processor 113 determines which access category the transmission packet belongs to according to the traffic identifier in the transmission packet. Then, the processor 113 determines a priority level of the transmission packet according to the access category to which the transmission packet belongs. In some embodiments, the processor 113 determines whether the traffic identifier in the transmission packet is greater than a priority level threshold. When the traffic identifier in the transmission packet is greater than the priority level threshold, it is determined that the priority level of the transmission packet is a high priority level, that is, the transmission packet is a high-priority packet. Conversely, when the traffic identifier in the transmission packet is not greater than the priority level threshold, it is determined that the priority level of the transmission packet is a low priority level, that is, the transmission packet is a low-priority packet. In an embodiment, when the traffic identifier in the transmission packet is “4,” “5,” “6,” or “7,” the processor 113 determines that the priority level of the transmission packet is a high priority level. When the traffic identifier in the transmission packet is “0,” “1,” “2,” or “3,” the processor 113 determines that the priority level of the transmission packet is a low priority level.

In step S533, when a priority level of a transmission packet is a high priority level, the processor 113 allows the interfered link to transmit the transmission packet. In step S534, when the priority level of the transmission packet is a low priority level, the processor 113 disables the interfered link from transmitting the transmission packet. Specifically, the processor 113 classifies the transmission packet according to a preset priority level threshold, allowing high-priority transmission packets (in an embodiment, voice or video data) to be transmitted in real time over the interfered link so as to ensure stability and data integrity of latency-sensitive applications. At the same time, the processor 113 performs a transmission restriction on low-priority transmission packets (in an embodiment, file downloads or background data) on the interfered link to reduce a load on the interfered frequency band and mitigate a negative impact of the interfered link on other links.

In step S540, when the priority level of the transmission packet is a low priority level, the processor 113 uses another link of the multi-link operation to transmit the transmission packet. An operating frequency band of the another link is different from the operating frequency band of the link. In an embodiment, when the processor 113 determines that a 5G frequency band is interfered, the processor 113 uses another link of the multi-link operation established on a 6G frequency band to transmit the transmission packet of the low priority level.

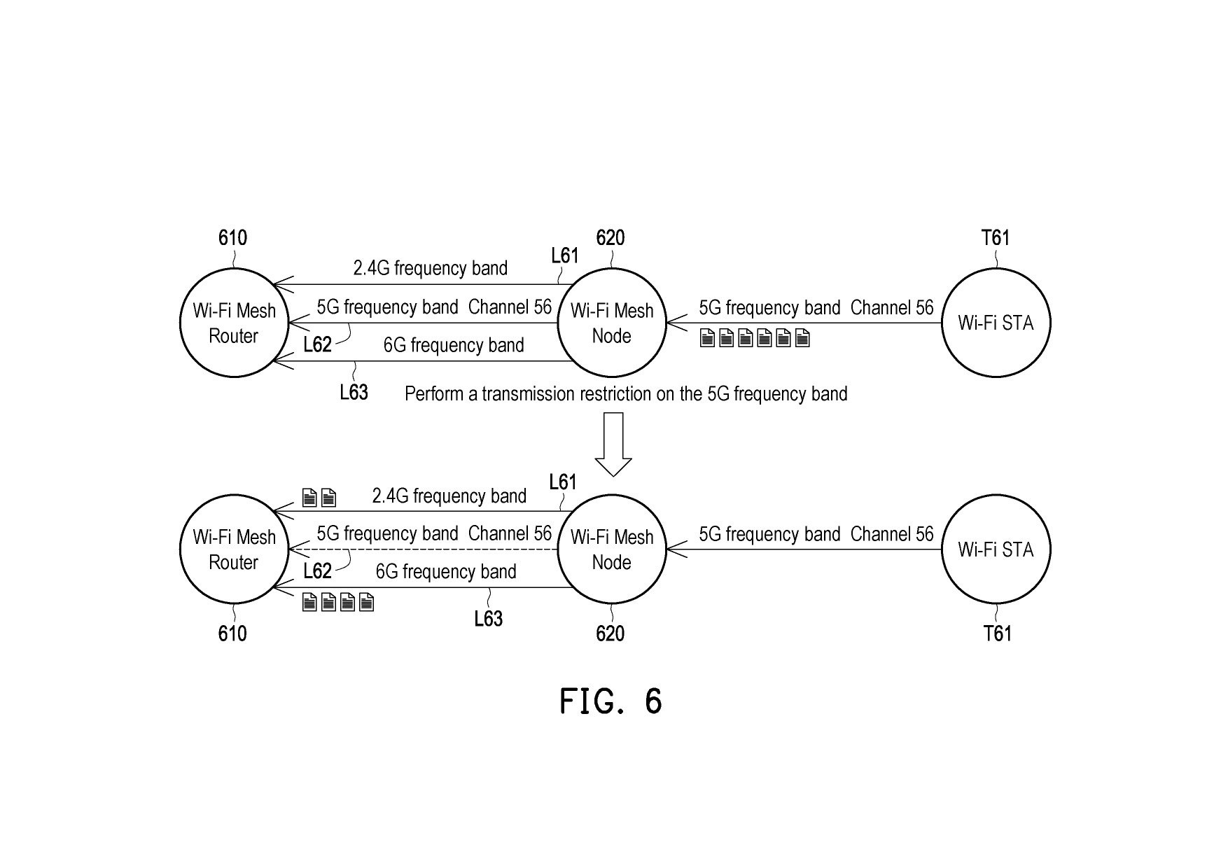

Referring to FIG. 6, which is a schematic diagram of a method for a frequency band usage management in a multi-link operation architecture according to an embodiment of the disclosure, a Wi-Fi Mesh router 610 establishes links L61 to L63 with a Wi-Fi Mesh node 620 on different frequency bands. An operating frequency band of the link L61 is a 2.4G frequency band. An operating frequency band of the link L62 is channel 56 of the 5G frequency band. An operating frequency band of the link L63 is a 6G frequency band. In addition, a Wi-Fi station (Wi-Fi STA) T61 is connected to the Wi-Fi Mesh node 620 through channel 56 of the 5G frequency band.

The Wi-Fi Mesh router 610 monitors a transmission status of operating frequency bands of the links L61 to L63. In this case, since the Wi-Fi STA T61 uses channel 56 of the 5G frequency band, the Wi-Fi Mesh router 610 determines that the operating frequency band of the link L62 is interfered. When the Wi-Fi Mesh router 610 determines that the operating frequency band of the link L62 is interfered, the Wi-Fi Mesh router 610 performs a transmission restriction on the link L62 according to a priority level of a transmission packet. The link L62 allows transmission packets of a high priority level to pass through but disables transmission packets of a low priority level from passing through. Assuming that the transmission packets from the Wi-Fi STA T61 are all low-priority packets, then these transmission packets will be disabled from being transmitted through the link L62 and will be scheduled for transmission through the links L61 and L63.

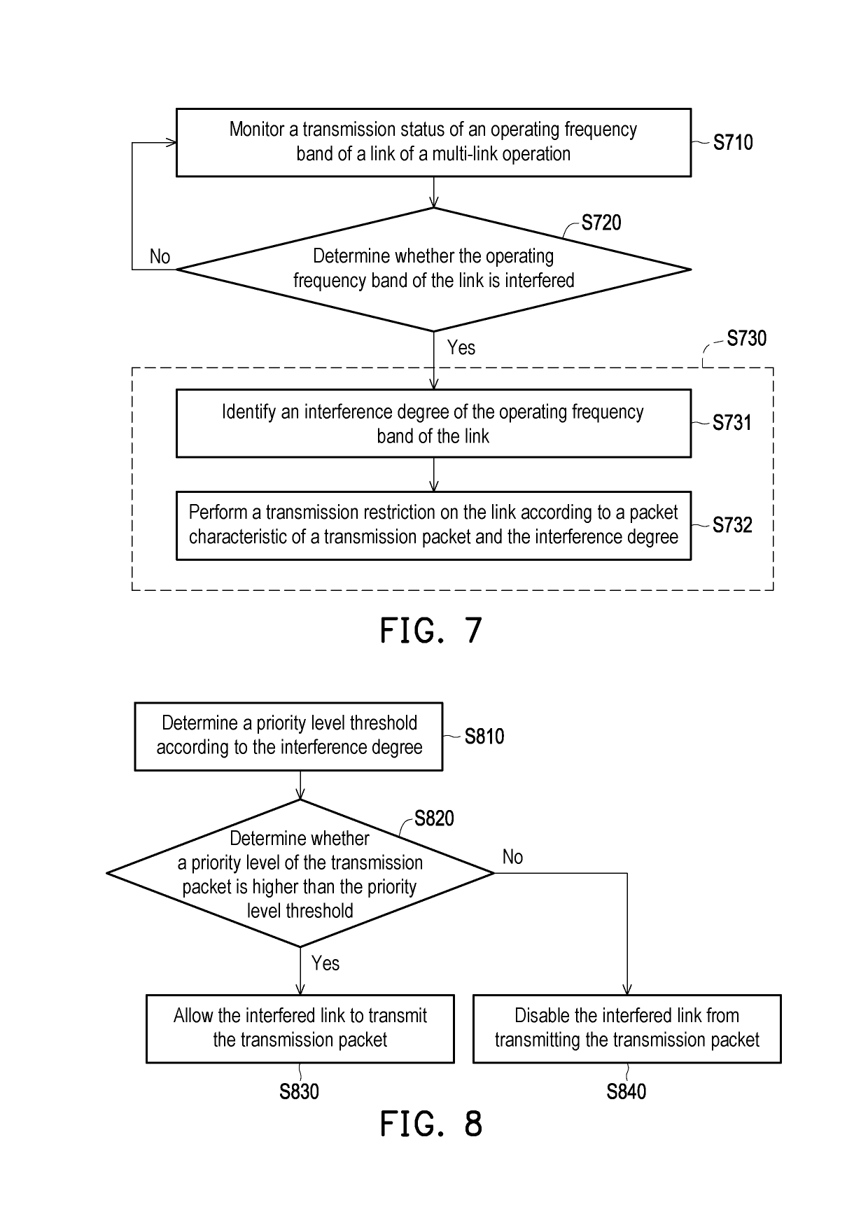

Referring to FIG. 7, which is a flowchart of a method for a frequency band usage management in a multi-link operation architecture according to an embodiment of the disclosure, the method of the this embodiment is executed by the wireless access point device 200 of FIG. 2, and the details of each step are described below with reference to the elements shown in FIG. 2.

In step S710, the processor 113 monitors a transmission status of an operating frequency band of a link of a multi-link operation. In step S720, the processor 113 determines whether the operating frequency band of the link is interfered. Detailed implementations of steps S710 to S720 is referred to the descriptions of the above embodiments and will not be repeated here.

In step S730, when the operating frequency band of the link is interfered, the processor 113 performs a transmission restriction on the link based on a packet characteristic of a transmission packet. In some embodiments, step S730 is implemented as steps S731 to S732.

In step S731, when the operating frequency band of the link is interfered, the processor 113 identifies an interference degree of the operating frequency band of the link. In some embodiments, the processor 113 evaluates the interference degree by monitoring the following parameters, such as channel utilization rate, packet loss rate, signal-to-interference ratio (SIR), or interference index, and so on. Based on these parameters, the processor 113 quantifies the interference degree and classify the interference into different levels (such as slight, moderate, or severe interference) for subsequent processing.

In step S732, the processor 113 performs a transmission restriction on the link according to a packet characteristic of a transmission packet and the interference degree. That is, in addition to the packet characteristic, the processor 113 also determines a transmission restriction rule of the interfered link according to a level of the interference degree. In some embodiments, the processor 113 dynamically determines a priority level threshold according to the interference degree. That is, the priority level threshold used to distinguish between high-priority packets and low-priority packets is dynamically determined according to the interference degree.

Referring to FIG. 8, which is a flowchart of performing a transmission restriction based on an interference degree and a packet characteristic according to an embodiment of the disclosure, in some embodiments, step S732 is implemented as steps S810 to S830.

In step S810, the processor 113 determines a priority level threshold according to the interference degree. In some embodiments, the priority level threshold increases as the interference degree increases. In some embodiments, the processor 113 determines the priority level threshold through a table lookup. In an embodiment, assuming that a priority level of a transmission packet is a TID of the transmission packet, when the interference degree is a severe interference degree, the processor 113 determines the priority level threshold as “6.” When the interference degree is a moderate interference degree, the processor 113 determines the priority level threshold as “5.” When the interference degree is a slight interference degree, the processor 113 determines the priority level threshold as “4.”

In step S820, when a priority level of a transmission packet is higher than a priority level threshold, the processor 113 allows the interfered link to transmit the transmission packet. Conversely, in step S830, when the priority level of the transmission packet is not higher than the priority level threshold, the processor 113 disables the interfered link from transmitting the transmission packet.

It is thus understood that when the interference degree is higher, the processor 113 increases the priority level threshold so as to allow just a small portion of transmission packets to pass through the interfered link. When the interference degree is lower, the processor 113 appropriately decreases the priority level threshold so as to allow more types of transmission packets to pass through. In an embodiment, when the interference degree is a severe interference degree, the processor 113 allows transmission packets with a TID of “6” or “7” to pass through the interfered link. When the interference degree is a moderate interference degree, the processor 113 allows transmission packets with a TID of “5,” “6,” or “7” to pass through the interfered link. Based on this, overall transmission efficiency is effectively improved while ensuring transmission stability of high-priority packets and operational flexibility under various interference environments.

In some embodiments, when the processor 113 determines that operating frequency bands of a plurality of links of a multi-link operation are interfered, the processor 113 performs a transmission restriction on a first link among the interfered links, but not performs a transmission restriction on a second link among the interfered links. A transmission performance of the first link is lower than a transmission performance of the second link. Or, an interference degree of the first link is higher than an interference degree of the second link. Based on this, it is ensured that one link is retained without being subject to a transmission restriction.

Any content of the respective embodiments of the disclosure, as well as any content of the same embodiment, is freely combined. Any combination of the above content is within the scope of the disclosure. In addition, a processing procedure of a method executed by at least one processor is not limited to the examples of the above embodiments. In an embodiment, a portion of the above steps is omitted, or the steps are executed in another order. Also, any two or more steps among the above steps are combined, or a portion of the steps is modified or deleted. Alternatively, steps other than the above steps may also be executed.

In summary, in the embodiment of the disclosure, when it is monitored that an operating frequency band of a link in the multi-link operation is interfered, a transmission restriction rule of the interfered link is configured to determine whether a transmission packet is scheduled to the interfered link according to a packet characteristic. That is, when it is monitored that the operating frequency band of a link in the multi-link operation is interfered, a transmission opportunity of the link will be restricted so as to ensure overall data transmission efficiency and stability of the multi-link operation.

In addition, when it is determined to perform a transmission restriction on the interfered link, allowed transmission packets on the interfered link is flexibly adjusted according to the packet characteristic and the interference degree, so as to reserve the interfered link for a smaller number of high-priority packets. Therefore, an occupation of the interfered link by low-priority packets is effectively reduced, thereby still ensuring timely transmission of high-priority data under an interference condition and realizing a low-latency advantage brought by the multi-link operation (MLO) technology. In addition, the method and the device is applied to a Wi-Fi Mesh architecture to significantly improve a quality and a performance of a network connection of the Mesh network.

Finally, it should be noted that the above embodiments are only used to illustrate the technical solutions of the disclosure and are not intended to limit the disclosure. Although the disclosure has been described in detail with reference to the above embodiments, those skilled in the art should understand that modifications may still be made to the technical solutions described in the above embodiments, or some or all of the technical features may be replaced with equivalents. These modifications or replacements do not cause the essence of the corresponding technical solutions to deviate from the scope of the technical solutions in the embodiments of the disclosure.

What is claimed is:

1. A method for a frequency band usage management in a multi-link operation architecture, comprising:
monitoring a transmission status of an operating frequency band of a link of a multi-link operation;
determining whether the operating frequency band of the link is interfered; and
performing a transmission restriction on the link based on a packet characteristic of a transmission packet when the operating frequency band of the link is interfered.

2. The method for the frequency band usage management in the multi-link operation architecture according to claim 1, wherein the step of performing the transmission restriction on the link based on the packet characteristic of the transmission packet when the operating frequency band of the link is interfered comprises:
performing the transmission restriction on the link according to a priority level of the transmission packet when the operating frequency band of the link is interfered.

3. The method for the frequency band usage management in the multi-link operation architecture according to claim 2, wherein the priority level of the transmission packet is determined according to a traffic identifier defined by Quality of Service.

4. The method for the frequency band usage management in the multi-link operation architecture according to claim 2, wherein the step of performing the transmission restriction on the link according to the priority level of the transmission packet when the operating frequency band of the link is interfered comprises:
allowing the interfered link to transmit the transmission packet when the priority level of the transmission packet is a high priority level; and
disabling the interfered link from transmitting the transmission packet when the priority level of the transmission packet is a low priority level.

5. The method for the frequency band usage management in the multi-link operation architecture according to claim 4, further comprising:
adopting another link of the multi-link operation to transmit the transmission packet when the priority level of the transmission packet is the low priority level,
wherein an operating frequency band of the another link is different from the operating frequency band of the link.

6. The method for the frequency band usage management in the multi-link operation architecture according to claim 1, wherein the step of performing the transmission restriction on the link based on the packet characteristic of the transmission packet when the operating frequency band of the link is interfered, comprises:
identifying an interference degree of the operating frequency band of the link when the operating frequency band of the link is interfered; and
performing the transmission restriction on the link according to the packet characteristic of the transmission packet and the interference degree.

7. The method for the frequency band usage management in the multi-link operation architecture according to claim 6, wherein the step of performing the transmission restriction on the link according to the packet characteristic of the transmission packet and the interference degree comprises:
determining a priority level threshold according to the interference degree;
allowing the interfered link to transmit the transmission packet when a priority level of the transmission packet is higher than the priority level threshold; and
disabling the interfered link from transmitting the transmission packet when the priority level of the transmission packet is not higher than the priority level threshold.

8. The method for the frequency band usage management in the multi-link operation architecture according to claim 7, wherein the priority level threshold increases as the interference degree increases.

9. The method for the frequency band usage management in the multi-link operation architecture according to claim 1, wherein after performing the transmission restriction on the link based on the packet characteristic of the transmission packet when the operating frequency band of the link is interfered, the method further comprises:
removing the transmission restriction on the link when the operating frequency band of the link is switched to be not interfered.

10. A wireless access point device, comprising:
a transceiver;
a storage device; and
a processor, coupled to the transceiver and the storage device, and configured to:
monitor a transmission status of an operating frequency band of a link of a multi-link operation;
determine whether the operating frequency band of the link is interfered; and
perform a transmission restriction on the link based on a packet characteristic of a transmission packet when the operating frequency band of the link is interfered.
